(19) United States
(12) Patent Application Publication
(10) Pub. No.: US 2007/0126338 A1
(43) Pub. Date: Jun. 7, 2007

(54) DISPLAY DEVICE

(76) Inventors: Kaoru KOIWA, Tokyo (JP); Koji Yamakawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/671,302

(22) Filed: Feb. 5, 2007

Related U.S. Application Data
(63) Continuation of application No. PCT/JP05/14105, filed on Aug. 2, 2005.

(30) Foreign Application Priority Data
Aug. 30, 2004 (JP) 2004-250202

(51) Int. Cl. H01J 63/04; H01J 1/00

(52) U.S. Cl. 313/495; 313/311

(57) ABSTRACT

A PED is constituted by arranging signal lines and scanning lines, in the form of a matrix, on the inner surface of a rear substrate and by forming PZT films, which are used as electron-emitting members, at the intersections of the signal lines and the scanning lines. When a voltage is applied between element electrodes connected to the lines, each PZT film emits an electron beam having a cross-section shape that depends on the shape of the PZT film.

### CROSS REFERENCE TO RELATED APPLICATIONS

This is a Continuation Application of PCT Application No. PCT/JP2005/014105, filed Aug. 2, 2005, which was published under PCT Article 21(2) in Japanese.

This application is based upon and claims the benefit of priority from prior Japanese Patent Application No. 2004-250202, filed Aug. 30, 2004, the entire contents of which are incorporated herein by reference.

### BACKGROUND OF THE INVENTION

1. Field of the Invention

The present invention relates to a display device in which the electron emission elements provided on the rear substrate emit electrons and the phosphor layers provided on the front substrate are excited, thereby displaying a color image.

2. Description of the Related Art

In recent years, field-emission displays (FEDs), plasma displays (PDPs) and like have been known as displays that have a vacuum envelope of flat-panel structure. Displays having electron emission elements of surface-conduction type (hereinafter referred to as SEDs) are now being developed as one type of FEDs.

The SED has a front substrate and a rear substrate, which are opposed to each other and spaced apart by a predetermined gap. These substrates are coupled with each other at edges, by a sidewall that is shaped like a rectangular frame. The substrates constitute a vacuum envelope which has a flat panel structure and the interior of which remains in a vacuum.

Phosphor layers that can emit three-color light beams are formed on the inner surface of the front substrate. On the inner surface of the rear substrate, a number of electron emission elements are arranged and used as sources of electrons, each corresponding to one pixel. On the inner surface of the rear substrate, too, a number of wires are arranged in the form of a matrix, for driving the electron emission elements. These wires are led, at one end, from the vacuum envelope.

Each electron emission element has a pair of element electrodes and a conductive film. The electrodes are connected to wires. The conductive film connects the element electrodes. A crack is made in the conductive film, between the element electrodes (see, for example, Jpn. Pat. Appln. KOKAI Publication No. 9-237571). To drive this electron emission element, an anode voltage is applied between the front substrate and the rear substrate in order to accelerate electrons, and then an element voltage is applied between the paired element electrodes. The electron emission element therefore emits electrons, which are jumped the crack and accelerated as they move toward the front substrate.

In the process of forming each electron emission element, a high pulse voltage is applied between the element electrodes after the conductive film has been formed, connecting the paired element electrodes. Joule heat is thereby generated, making a crack in the conductive film. To stabilize the width of the crack, i.e., a gap, a pulse voltage is applied between the paired element electrodes in a organic-gas atmosphere, thereby sticking carbon to the edges of the crack.

As described above, many steps must be performed in order to manufacture the electron emission elements of the conventional SED. This increases the manufacturing cost. In particular, the forming process that makes a crack in the conductive film must be carried out in a vacuum, and the activation process of sticking carbon to the rack must be performed in a predetermined organic-gas atmosphere. Much time is required to prepare these atmospheres. Consequently, it takes a long time to manufacture the SED.

In manufacturing the conventional SED, Joule heat is applied, making a crack in the conductive film and thereby forming an electron-emitting unit. Hence, even if the activation process is performed to stick carbon, each electron emission element will have a gap different form that in any other element. As a result, the electron emission elements may differ in terms of electron-emitting characteristic.

In the conventional SED, the electron beam emitted from each electron emission element is elongated. Inevitably, the beam spot is elongated, too. Consequently, each phosphor layer is degraded at a limited part, which inevitably shortens the lifetime of the entire phosphor layer.

### BRIEF SUMMARY OF THE INVENTION

An object of the present invention is to provide a display device which can be easily manufactured at low cost and in which each electron emission element has stable electron-emitting characteristic and can emit an electron beam that can have a shape as desired.

To achieve this object, a display device according to this invention is characterized by having a vacuum envelope constituted by opposing a front substrate having a plurality of phosphor layers, to a rear substrate having a plurality of electron emission elements corresponding to the phosphor layers, respectively, and wires for driving the electron emission elements, by aligning the front substrate and the rear substrate in position, by bonding the front substrate and the rear substrate to each other at peripheral edges, and by generating a vacuum in the envelope, thus forming an envelope. Each of the electron emission elements has: a pair of element electrodes which are connected to the wires; and an electron-emitting member. The electron-emitting member is made of material that emits electrons when a potential is applied between the element electrodes connected to the electron-emitting member.

According to the invention, electrons can be emitted only by applying a voltage to the electron-emitting member that connects a pair of electrodes. This helps to simplify the structure of the electron emission element. Further, the shape and characteristic of the electron beam can be changed by changing the shape and thickness of the electron-emitting member. Therefore, an electron beam having a desired characteristic can be emitted.

Another display device according to the present invention is characterized by having a vacuum envelope constituted by opposing a front substrate having a plurality of phosphor layers, to a rear substrate having a plurality of electron emission elements corresponding to the phosphor layers, respectively, by aligning the front substrate and the rear substrate in position, by bonding the front substrate and the rear substrate to each other at peripheral edges, and by generating a vacuum in the envelope, thus forming an envelope. Each of the electron emission elements has an electron-emitting member which is configured to emit electrons when heated to a predetermined temperature; and a heater which heats the electron-emitting member to the predetermined temperature.

According to this invention, the heater of each electron-emitting member is operated to emit electrons. This helps to simplify the structure of the electron emission element. Further, the shape and characteristic of the electron beam can be changed by changing the shape and thickness of the electron-emitting member. Therefore, an electron beam having a desired characteristic can be emitted.

### BRIEF DESCRIPTION OF THE SEVERAL VIEWS OF THE DRAWING

FIG. 1 is a perspective view showing the outer appearance of the vacuum envelope of a PED according to an embodiment of the present invention;

FIG. 2 is a sectional perspective view of the vacuum envelope of FIG. 1, taken along line II-II;

FIG. 3 is a magnified sectional view of a part of the envelope shown in FIG. 2;

FIG. 4 is a plan view showing the wiring configuration of an electron emission element of the PED; and

FIG. 5 is a flowchart explaining a method of manufacturing the electron emission element shown in FIG. 4.

### DETAILED DESCRIPTION OF THE INVENTION

An embodiment of the present invention will be described, with reference to the accompanying drawings.

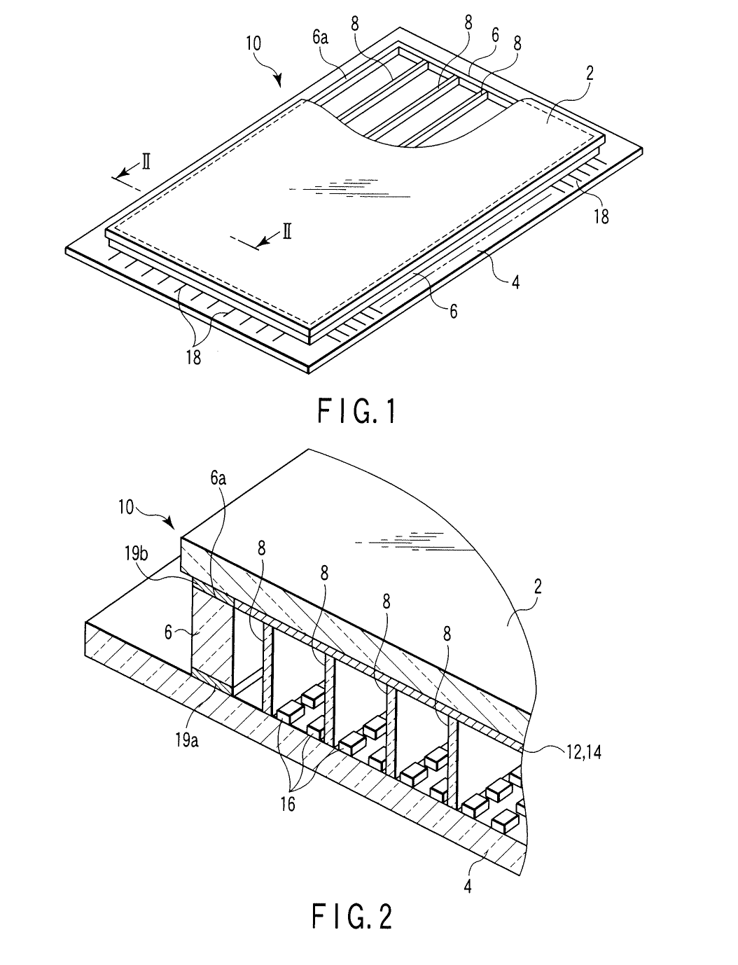

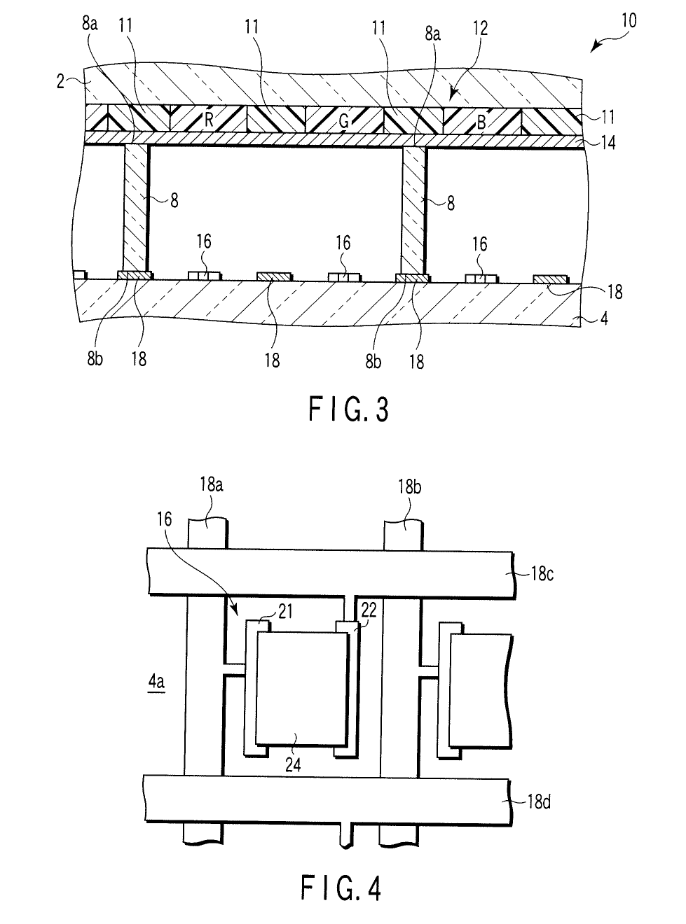

First, a pyroelectric emission display (PED), which is a display device according to this invention, will be described with reference to FIGS. 1 to 3. FIG. 1 is a perspective view of the vacuum envelope 10 of the PED, showing the front substrate partly cut away. (Hereinafter, the envelope 10 may be also called display panel 10.) FIG. 2 is a sectional view of the vacuum envelope 10 shown in FIG. 1, taken along line II-II. FIG. 3 is a magnified sectional view of a part of the envelope shown in FIG. 2.

As shown in FIG. 1 to FIG. 3, the display panel 10 comprises a front substrate 2 and a rear substrate 4, which are rectangular glass plates. The substrates 2 and 4 are opposed to each other, arranged parallel to each other and spaced apart by a gap of about 1.0 to 2.0 mm. The rear substrate 4 has is larger in sized than the front substrate 2. The front substrate 2 and the rear substrate 4 are coupled, at peripheral edges, by a sidewall 6 that is a rectangular frame made of glass. They constitute a vacuum envelope of flat-panel structure, in which a vacuum is maintained.

A phosphor screen 12 is formed on the inner surface of the front substrate 2. The screen 12 functions as image display screen. The phosphor screen 12 comprises red phosphor layers R, blue phosphor layers B, green phosphor layers G, and light-shielding layers 11. The phosphor layers are provided in the form of stripes or dots. A metal-back layer 14 made of aluminum is formed on the phosphor screen 12.

On the inner surface of the rear substrate 4, a number of electron emission elements 16 are provided. The electron emission elements 16 are sources of electrons and emit electron beams, which will excite the phosphor layers R, G and B of the phosphor screen 12. The electron emission elements 16 are arranged in rows and columns, each provided for one pixel composed of a phosphor layer R, a phosphor layer G and a phosphor layer B. Each electron emission element 16 comprises an electron-emitting member 24 (see FIG. 4) and a pair of element electrodes 21 and 22 (see FIG. 4). The member 24 will be described later. The element electrodes 21 and 22 are used to apply a voltage to the electron-emitting member. On the inner surface of the rear substrate 4, a number of wires 18 are arranged in the form of a matrix, to apply a drive voltage to each electron emission element 16. The wires are led, at one end, from the vacuum envelope 10.

The sidewall 6 that functions as coupling member is bonded to the peripheral edges of the front substrate 2 and the peripheral edges of the rear substrate 4, with sealing material 19 such as lo-melting glass or low-melting metal, thus bonding the substrates to each other. In the present embodiment, the sidewall 6 is bonded to the rear substrate 4 by using frit glass 19a, and is bonded to the front substrate 2 by using indium 19b. Low-melting metal may be used to bond the sidewall 6 to the rear substrate 4 on which the wires 18 are provided. In this case, an insulating layer must be provide as intermediate layer, in order to avoid short circuiting between any wire 18 and the sealing material 19.

The display panel 10 has a plurality of spacers 8, which are provided between the front substrate 2 and the rear substrate 4. The spacers 8 are elongated plates made of glass. The spacers 8 are elongated glass plates in this embodiment. Instead, they may be a number of pillar-like spacers (not shown) which are integrally formed with a grid (not shown) that is a rectangular metal plate and which stand on both surfaces of the grid.

Each spacer 8 has an upper end 8a and a lower end 8b. The upper end 8a abuts on the light-shielding layers 11 of the phosphor screen 12, which in turn abuts on the inner surface of the front substrate 2. The lower end 8b abuts on the wires 18 provided on the inner surface of the rear substrate 4. Thus, the spacers 8 support the front substrate 2 and the rear substrate 4 against the atmospheric pressure exerted to the outer surface of the rear substrate 4, maintaining the gap between the substrates at a predetermined value.

The PED further comprises a voltage-applying unit (not shown), which applies an anode voltage between the metal-back layer 14 of the front substrate 2 and the rear substrate 4. The voltage-applying unit applies an anode voltage between the metal-back layer 14 and the rear substrate 4 so that the potentials of the rear substrate 4 and metal-back layer 14 may be set to, for example, 0V and about 10 kV, respectively.

In the PED, a voltage is applied between the element electrodes of any selected electron emission element 16 via a drive circuit (not shown) that is connected to the wires 18, in order to display an image. The electron-emitting members of selected electron emission elements emits electron beams. Meanwhile, an anode voltage is applied to the metal-back layer 14. The anode voltage accelerates the electron beams emitted from the electron emission elements. The electron beams are applied to the phosphor screen 12, exciting the phosphor layers R, G and B of the screen 12. The phosphor layers emit color light beams. As a result, the PED displays a color image.

To manufacture the display panel 10 configured as described above, the front substrate 2 is prepared, with the phosphor screen 12 and the metal-back layer 14 already provided on it. The rear substrate 4 is prepared, too, with the element emission elements 16 and the wires 18 already provided on it. Then, the front substrate 2 and the rear substrate 4 are arranged in the vacuum chamber (not shown). After the vacuum chamber is evacuated, generating a vacuum in it, the front substrate 2 is bonded to the rear substrate 4, with the sidewall 6 interposed between the substrates 2 and 4. The display panel 10 having a plurality of spacers 8 is thereby manufactured.

FIG. 4 is a plan view schematically depicting one of the electron emission elements 16 provided the present embodiment of this invention, as viewed from the inner surface of the rear substrate 4. The electron emission element 16 has a pair of element electrodes 21 and 22 and an electron-emitting member 24. The electrodes 21 and 22 are connected to wires 18. The member 24 connects the element electrodes 21 and 22.

More specifically, wires 18, i.e., signal lines 18a and 18b and scanning lines 18c and 18d are arrange on the inner surface 4a of the rear substrate 4. The signal lines 18a and 18b are insulated from the scanning lines 18c and 18d, by a barrier-metal layer (not shown). The lines 18a, 18b, 18c and 18d are arranged in the form of a matrix. One electron emission element 16 is formed at the intersection of one signal line and one scanning line. In the case of FIG. 4, one element electrode 21 is connected to the signal line 18a, the other element electrode 22 is connected to the scanning line 18c. A PZT film 24, i.e., electron-emitting member, is provided and connects the paired element electrodes.

The PZT film 24 is a ferroelectric film, which is thin and made of an oxide containing zinc (Zn) and titanium (Ti). The film 24 emits electrons when a predetermined voltage is applied between the element electrodes 21 and 22 that contact this thin film. That is, the PZT film 24 is heated, emitting electrons from its surface, when the predetermined voltage is applied between the paired element electrodes 21 and 22. The electrons are accelerated by the anode voltage and cause the phosphor layers R, G and B to emit light. Electrons may be emitted from the surface of the PZT film 24 by heating the PZT film 24 to a predetermined temperature by means of a heater or the like.

Known as a device using a PZT film as an electron source is the semiconductor device that is disclosed in Integrated Ferroelectrics, 2001, Vol. 41, pp. 17-25. The reference teaches that BaTiO₃ can be used as an electron source. Hence, BaTiO₃ can be used in the device according to this invention, in place of the PZT film 24.

In the present embodiment, the ferroelectric film 24, e.g., PZT film, is rectangular in conformity with the shape of the phosphor layers R, G and B. This is because the shape of the spot of the electron beam emitted from the film 24 is determined by the shape of the film 24. Since the film 24 has almost the same shape as the phosphor layers, electron beams can be efficiently applied to almost all area of each phosphor layer. Nonetheless, the PZT film 24 may have an oblate shape that is similar to the shape of the phosphor layers.

In other words, since the PZT film 24 is used as an electron-emitting member, the shape of the electron beam can be designed to any shape desired. This can increase the emission efficiency of the phosphor layers R, G and B, ultimately enhancing the display luminance and lengthening the lifetime of the phosphor layers. That is, the beam spot can have a desired shaped, preventing the application of the electron beam to only a limited part of each phosphor layer R, G or B. Hence, the lifetime of phosphor layers can be lengthened.

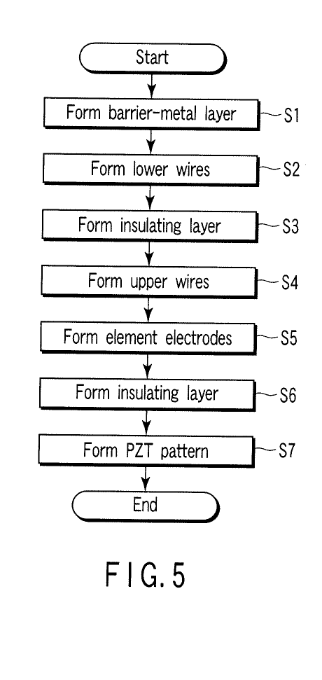

A method of manufacturing each electron emission elements 16 will be explained, with reference to FIG. 4 and the flowchart of FIG. 5.

First, sputtering is performed, coating the inner surface 4a of the rear substrate 4 with platinum and thus forming a barrier-metal layer (Step S1). Lower wires, i.e., signal lines 18a and 18b, are formed by applying photoresist (Step S2). Subsequently, an insulting layer is formed (Step S3). Upper wires, i.e., scanning lines 18c and 18d, are formed by means of silver-paste printing (Step S4).

Next, a pair of element electrodes 21 and 22 are formed (Step S5). A PZT film 24 is formed on an insulating layer and patterned, thus connecting the electrodes 21 and 22 (Step S7). At this time, a PZT film is formed by sputtering and a resist layer is formed by spin-coating or spray-coating. The resist is exposed to light, using a predetermined mask pattern. The resist is the peeled off, forming a pattern.

Alternatively, ink prepared by mixing PZT particles made by crushing, with a binder, may be printed and baked, thereby to provide a pattered PZT film 24.

Thus, the electron emission element 16 can be produced in simple steps, reducing the manufacturing cost of the display device. To manufacture each electron emission element 16, it is not necessary to make a crack in the forming process and stick carbon to the crack as in the method of manufacturing the electron emission elements of, for example, an SED, after forming the conductive film that connects the element electrodes. Hence, electron emission elements can be provided, which do not differ in terms of electron-emitting characteristic.

The present invention is not limited to the embodiment described above. The components of any embodiment can be modified in various manners in reducing the invention to practice, without departing from the sprit or scope of the invention. Further, the components of any embodiment described above may be combined, if necessary, in various ways to make different inventions. For example, some of the component of any embodiment may not be used. Moreover, the components of the different embodiments may be combined in any desired fashion.

The display device according to the present invention is configured and operates, as described above. Therefore, the electron emission elements provided in the device can be easily manufactured at low cost and have stable electron-emitting characteristic, and the electron beams emitted from the electron emission elements can have such a shape as desired.

What is claimed is:

1. A display device having a vacuum envelope constituted by opposing a front substrate having a plurality of phosphor layers, to a rear substrate having a plurality of electron emission elements corresponding to the phosphor layers, respectively, and wires for driving the electron emission elements, by aligning the front substrate and the rear substrate in position, by bonding the front substrate and the rear substrate to each other at peripheral edges, and by generating a vacuum in the envelope, thus forming an envelope,
each of the electron emission elements having:
a pair of element electrodes which are connected to the wires; and
an electron-emitting member which is provided, connecting the paired element electrodes,
the electron-emitting member being made of material that emits electrons when a potential is applied between the element electrodes connected to the electron-emitting member.

2. The display device according to claim 1, wherein the electron-emitting member is constituted by a ferroelectric film such as PZT film.

3. The display device according to claim 2, wherein the ferroelectric film is substantially rectangular in conformity with a shape of the phosphor layers.

4. The display device according to claim 2, wherein the ferroelectric film is oblate.

5. The display device according to claim 1, wherein the electron-emitting member is made of BaTiO₃.

6. A display device having a vacuum envelope constituted by opposing a front substrate having a plurality of phosphor layers, to a rear substrate having a plurality of electron emission elements corresponding to the phosphor layers, respectively, by aligning the front substrate and the rear substrate in position, by bonding the front substrate and the rear substrate to each other at peripheral edges, and by generating a vacuum in the envelope, thus forming an envelope,
each of the electron emission elements having:
an electron-emitting member which is configured to emit electrons when heated to a predetermined temperature; and
a heater which heats the electron-emitting member to the predetermined temperature.

7. The display device according to claim 6, wherein the electron-emitting member is constituted by a ferroelectric film such as PZT film.

8. The display device according to claim 7, wherein the ferroelectric film is substantially rectangular in conformity with a shape of the phosphor layers.

9. The display device according to claim 7, wherein the ferroelectric film is oblate.

10. The display device according to claim 6, wherein the electron-emitting member is made of BaTiO₃.
